(19) United States
(12) Patent Application Publication
(10) Pub. No.: US 2025/0221383 A1
(43) Pub. Date: Jul. 10, 2025

(54) Pet Harness with GPS

(71) Applicant: Miethner Creative Group LLC, Oceanside, NY (US)

(72) Inventors: Ian Berk, Oceanside, NY (US); Emily Miethner, Oceanside, NY (US)

(21) Appl. No.: 19/015,221

(22) Filed: Jan. 9, 2025

Related U.S. Application Data
(60) Provisional application No. 63/618,959, filed on Jan. 9, 2024.

(51) Int. Cl. A01K 27/00; A01K 11/00

(52) U.S. Cl. CPC A01K 27/008; A01K 11/008; A01K 27/002

(57) ABSTRACT

A pet harness system featuring GPS tracking capabilities and is configured to secure a pet safely and comfortably within the harness. More specifically, the pet harness includes a housing to retain a gps tracking device which is capable of communicating a location to a receiving device.

### CROSS REFERENCE TO RELATED APPLICATION

This application claims priority to and takes the benefit of Provisional Patent Application Ser. No. 63/618,959 filed on Jan. 9, 2024, the contents of which are herein incorporated by reference.

### FIELD OF THE INVENTION

The present invention relates to a harness configured to fit a cat or domestic pet which comprises a housing for a unit using global positioning signal (“GPS”), wherein the GPS unit is capable of transmitting the coordinates of the pet wearing the harness to a receiving device. The housing is configured to allow for easy installation and removal of the GPS unit.

### DESCRIPTION OF RELATED ART

Animals, such as cats, domesticated animals or pets that run free are at risk for injury and death from moving cars, other animals, getting lost, or many other dangers that exist outdoors. Cats are also exposed to many of these same risks, and more, during times of travel. For at least this reason, many have attempted to protect cats by providing a harness that attaches to cat and to a leash.

A properly fitting, comfortable harness that is acceptable by the cat can provide a way of safely controlling, securing, and restraining the cat during times of travel, on outdoor walks, in unfamiliar surroundings, in risky settings, such as unscreened terraces or balconies, and in most any environment a person wishes to be able to control or restrain their cat.

Tracking the location of animals such as cats, domesticated animals or pets that can move in unknown directions over a considerable range of territory has been a concern for a number of years. Although many pet species have keen senses of direction, it is not uncommon for pets to wander from their homes and become lost. Many pet owners have no reliable mechanism for locating their pets when they are lost.

Further, a number of systems have been proposed which employ existing wireless communication capabilities but which tend to be cumbersome, bulky, expensive or all of the above. Through the use of global positioning satellite system (GPS) services, it is possible to provide relatively inexpensive location systems for determining the location of moving objects. Therefore, there is a need for a secure and comfortable pet harness which houses a GPS unit that is not bulky or cumbersome.

### SUMMARY OF THE INVENTION

The instant apparatus and system, as illustrated herein, is clearly not anticipated, rendered obvious, or even present in any of the prior art mechanisms, either alone or in any combination thereof.

It is an object of the present is to provide a pet harness configured to secure to a pet, and house a GPS tracking unit. This objective can be achieved by the pet harness according to the present model, the pet harness comprising at least one housing configured to house a GPS unit. Such a pet harness is comprised of a unitary harness with at least two buckle and strap mechanisms on the upper and lower portion of the of the harness, comprising a collar and waistband. The pet harness further comprises a housing located on an upper portion of the harness. The housing is preferably made of plastic, such as polyvinyl chloride (“PVC”), and is capable of housing a GPS unit in a casing.

In one embodiment, the pet harness is comprised of mesh and reflective binding materials. The pet harness includes a unitary piece of material with a shape that has a central spine portion. A waistband extends perpendicular to the spine portion at a bottom portion of the spine and a collar extends perpendicular from the spine portion at a top portion of the spine.

In one embodiment, the pet harness includes buckle mechanisms on the collar and the waistband to further secure the pet. The waistband also includes a Velcro mechanism on the end of the waistband to further secure the pet in the pet harness.

In one embodiment, the pet harness is a harness with at least one housing capable of installing and removing a GPS unit and providing a casing for the GPS unit. The housing is further secured by a flap and at least one buckle mechanism. The housing is configured to provide a casing for a GPS unit that is not bulky or uncomfortable to the pet and allow easy removal of a GPS unit.

Preferably, the housing is sewn to and attached to the upper portion of the harness which sits on the back of the pet, in the center of the collar portion. The housing is preferably a clear plastic PVC material with a flap, the flap having a buckle mechanism which dynamically secures the flap closed.

Preferably, the GPS unit is small enough to fit in the housing and is capable of tracking a pet and sending coordinates to a receiving device.

In one embodiment, the pet harness further comprises a D-ring sewn to and attached to the pet harness at the lower portion of the central spine which is capable of receiving a leash or tether.

There has thus been outlined, rather broadly, the more important features of a pet harness and thus, the description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction, assembly and arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present device in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present device will be apparent from the following brief description of exemplary embodiments thereof; which description should be considered in conjunction with the accompanying drawings. Having thus described the invention in general terms, reference will now be made to the accompanying drawings, which are not necessarily drawn to scale. The system may be more completely understood in consideration of the following detailed description of various embodiments of the system in connection with the accompanying drawings, in which:

FIG. 1 is a top plan view of the embodiment of the pet harness according to the present disclosure and further illustrating distinct individual features of the pet harness according to the present disclosure.

FIG. 2 is a top plan view of the embodiment of the pet harness according to the present disclosure as illustrated in FIG. 2, further illustrating distinct individual features of the pet harness showing the harness engaged according to the present disclosure.

FIG. 3 is a side view of the collar portion of the pet harness according to the present disclosure in the engaged position.

FIG. 4 is a top plan view of one embodiment of the tractive device within an embodiment of a housing of the pet harness according to the present disclosure.

FIG. 5 is an additional top plan view of one embodiment of the tractive device and the housing, removed from the pet harness according to the present disclosure.

FIG. 6 illustrates an additional side plan view of one embodiment of the tractive device and the housing, removed from the pet harness according to the present disclosure.

FIG. 7 is a perspective view of an additional embodiment of the pet harness according to the present disclosure illustrating numerous color and pattern configurations.

### DETAILED DESCRIPTION OF THE SEVERAL EMBODIMENTS

The detailed description set forth below is intended as a description of presently preferred embodiments of the system and does not represent the only forms in which the present system may be construed and/or utilized. The description sets forth the functions and the sequence of the steps for producing the system and accompanying apparatus. However, it is to be understood that the same or equivalent functions and sequences may be accomplished by different embodiments and also intended to be encompassed within the scope of the system.

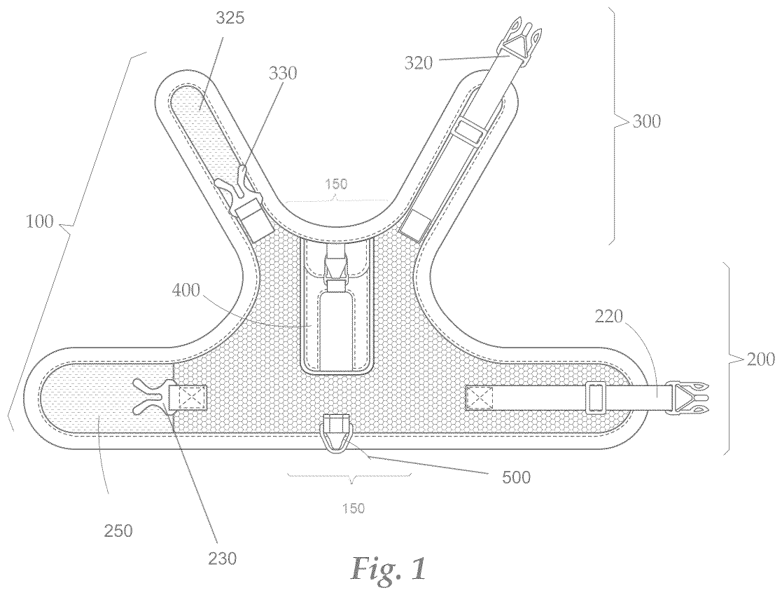

FIG. 1 is an exemplary embodiment of a pet harness 100 as shown. The pet harness 100 is comprised of a central spine portion 150 with a waistband portion 200 at a lower end of the central spine portion 150 and a collar portion 300 at the upper end of the central spine portion 150. The waistband portion 200 and collar portion 300 are configured to secure a pet into the pet harness 100. The pet harness 100 is preferably comprised of a breathable mesh fabric and reflective binding.

A D-ring 500 may be sewn to and attached to the central spine portion 150 of the pet harness 100 at the lower end of the central spine portion 150, and in the middle of the waistband portion 200. The D-ring 500 may be comprised to sit in the middle of the back of the pet and allows the user to attach a leash or tether to the pet harness 100. The waistband portion 200 further comprises a lower Velcro mechanism 250 on the underside of the waistband portion 200 which is configured to further secure the ends of the waistband portion 200 together. The collar portion 300 further comprises an upper Velcro mechanism 325 on the underside of the collar portion 300 which is configured to further secure the ends of the collar portion 300 together.

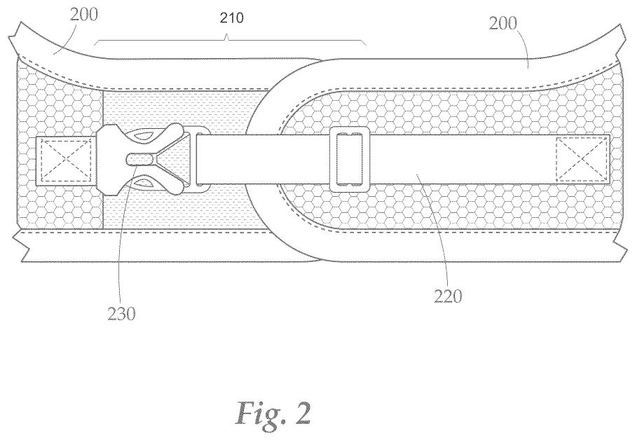

FIG. 2 illustrates an additional embodiment of the waistband portion 200 configured to wrap around the waist of the pet and secure the pet harness 100 on the pet. The waistband portion 200 may further include one or more, but at least one buckle mechanism 210, the at least one buckle mechanism 210 having a buckle 220 and a receiver member 230. The at least one buckle mechanism 210 is adjustable to the size of the pet wearing the pet harness 100.

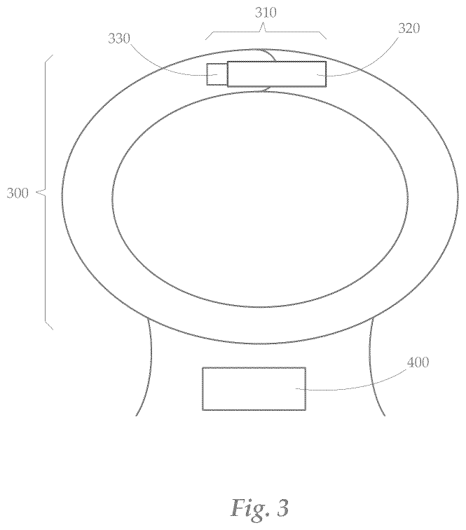

FIG. 3 illustrates an additional embodiment of the collar portion 300 configured to wrap around the neck of the pet and secure the pet harness 100 on the pet. The collar portion 300 is further comprised of at least one buckle mechanism 310, the at least one buckle mechanism 310 having a buckle 320 and a receiver 330. The at least one buckle mechanism 310 is adjustable to the size of the pet wearing the pet harness 100.

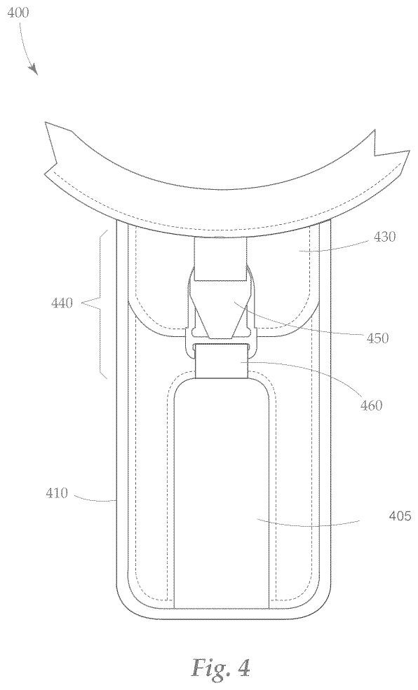

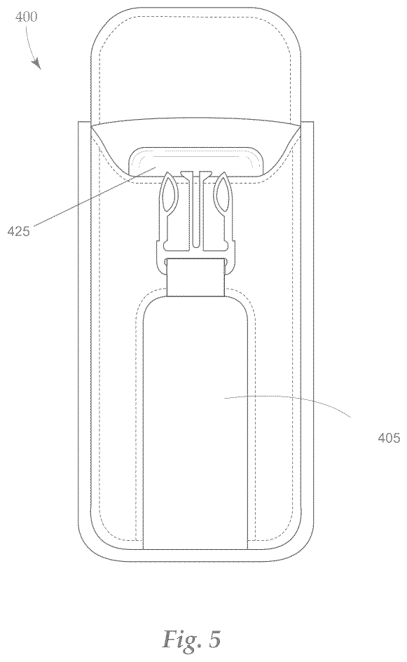

FIG. 4 illustrates a further embodiment of a housing 400, preferably fabricated from a polymeric material such as a plastic PVC. The housing 400 may be removably attached, or permanently attached by all methods known within the art, to the central spine portion 150 of the pet harness 100. The housing 400 may be configured with a casing 405 to house a GPS tracking device 425 within the housing 400 (see FIGS. 5-7). The housing 400 has a pouch 410 wherein the GPS tracking device 425 is secured within the housing. In some embodiments, the pouch 410 may be a GPS unit retaining area within the casing 405, residing by all methods known within the art. The housing 400 is secured by a flap 430 which is further secured by a buckle mechanism 440. The buckle mechanism 440 is comprised of a buckle 450 and a receiver 460.

FIG. 5 illustrates an additional top plan view of one embodiment of the casing 405 and the housing 400, removed from the pet harness 100. Furthermore, the GPS tracking device 425 resides in the casing 405.

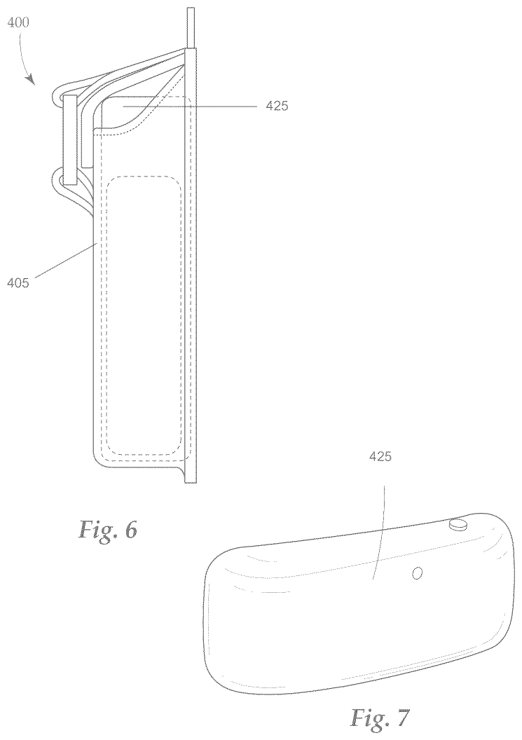

FIG. 6 illustrates a side plan view of an additional embodiment of the pet harness 100. The housing 400 may be removably attached, or permanently attached by all methods known within the art, to the central spine portion 150 of the pet harness 100. According to the present disclosure, the pet harness 100 can be configured to include numerous color and pattern configurations. Furthermore, the casing 405 is comprised to accommodate the GPS tracking device 425.

FIG. 7 is a perspective view of an additional embodiment of the pet harness 100 according to the present disclosure illustrating the GPS tracking device 425. In a preferred embodiment, the GPS tracking device 425 can be configured to be smaller for small harnesses and animals.

While the system is amenable to various modifications and alternative forms, specifics thereof have been shown by way of example in the drawings and will be described in detail. It should be understood, however, that the intention is not to limit the system to the particular embodiments described. On the contrary, the intention is to cover all modifications, equivalents, and alternatives falling within the spirit and scope of the system.

What is claimed is:

1. A pet harness comprising:
a central spine; the central spine further comprising:
a housing for a gps tracking device, the housing further comprising:
a casing fastened to the housing,
a pouch for the gps tracking device created in between the casing and the housing,
a flap, and
a buckle mechanism, the buckle mechanism comprising:
a buckle member, and
a receiver member;
a waistband portion extending from the lower end of the central spine in two distal directions, the waistband portion further comprising:
a Velcro mechanism, and
a buckle mechanism, the buckle mechanism comprising:
a buckle member, and
a receiver;
a collar portion, extending from the upper end of the central spine in two distal directions, the collar portion further comprising:
a buckle mechanism, the buckle mechanism comprising:
a buckle member, and
a receiver; and
a D-ring member located at the lower end of the central spine, wherein the pet harness is configured to adjust to a size of a pet and secures the pet in the pet harness safely and comfortably.

2. The pet harness of claim 1, wherein the housing is located at an upper portion of the central spine portion, at the collar portion, and is configured as a casing for the gs and is secured with a buckle mechanism connected to a flap of the housing.

3. The pet harness of claim 1, wherein the D-ring is sewn to and attached to the pet harness at a lower portion of the spine, in a center of the waistband portion, and is configured to receive a leash or tether.

4. The pet harness of claim 1, wherein the pet harness is comprised of a breathable mesh and a reflective binding.

5. The pet harness of claim 1, wherein the housing is comprised of a quantity of polyvinyl chloride (“PVC”).

6. A pet harness comprising:
a central spine, the central spine further comprising:
a housing for a gps tracking device, the housing further comprising:
a gps tracking unit;
a casing fastened to the housing,
a pouch for the gps tracking device created in between the casing and the housing,
a flap, and
a buckle mechanism, the buckle mechanism comprising:
a buckle member, and
a receiver member;
a waistband portion extending from the lower end of the central spine in two distal directions, the waistband portion further comprising:
a Velcro mechanism, and
a buckle mechanism, the buckle mechanism comprising:
a buckle member, and
a receiver;
a collar portion, extending from the upper end of the central spine in two distal directions,
the collar portion further comprising:
a buckle mechanism, the buckle mechanism comprising:
a buckle member, and
a receiver; and
a D-ring member located at the lower end of the central spine, wherein the pet harness is configured to adjust to a size of a pet and secures the pet in the pet harness safely and comfortably.

7. The pet harness of claim 6, wherein the housing is located at an upper portion of the central spine portion, at the collar portion, and is configured as a casing for the gps and is secured with a buckle mechanism connected to a flap of the housing.

8. The pet harness of claim 6, wherein the D-ring is sewn to and attached to the pet harness at a lower portion of the spine, in a center of the waistband portion, and is configured to receive a leash or tether.

9. The pet harness of claim 6, wherein the pet harness is comprised of a breathable mesh and a reflective binding.

10. The pet harness of claim 6, wherein the housing is comprised of a quantity of polyvinyl chloride (“PVC”).
